(19) United States
(12) Patent Application Publication
(10) Pub. No.: US 2026/0168554 A1
(43) Pub. Date: Jun. 18, 2026

(54) SNUBBER BRACKET

(71) Applicant: FCA US LLC, Auburn Hills, MI (US)

(72) Inventors: Spoorthi Medishetty, Chennai (IN); Sanjay N Patil, Auburn Hills, MI (US); Kalid S Jaboo, Auburn Hills, MI (US); Swapnil A Nanaware; Jeffrey C Muehl, Auburn Hills, MI (US); Santosh Pethe, Auburn Hills, MI (US); Niroop Venkat Konathala, Chennai (IN); Rahul Gurudatt Mutkiri, Chennai (IN)

(21) Appl. No.: 18/981,873

(22) Filed: Dec. 16, 2024

(51) Int. Cl. F16F 7/12; B60R 16/04; H01M 50/242; H01M 50/249

(52) U.S. Cl. CPC F16F 7/12; B60R 16/04; H01M 50/242; H01M 50/249; H01M 2220/20

(57) ABSTRACT

A snubber bracket has a body. A reinforcing nose extends from the body that provides a crush zone for a snubber. An elongated tail extends from the body. The tail contacts a battery extension to prohibit contact of the snubber bracket with the battery pack.

### FIELD

The present disclosure relates to automotive vehicles and, more particularly, to a rear cradle snubber bracket.

### BACKGROUND

This section provides background information related to the present disclosure which is not necessarily prior art.

Snubber brackets are part of a rear cradle subsystem. Generally, a rear cradle crossmember, with rubber mounts, is positioned near an electric drive module. The snubber brackets are bolted together with rubber mounts to dampen impact and are used as stoppers to avoid any direct interaction with the rubber mounts.

Some solutions exist to overcome the damage to high voltage battery module. One solution is to increase the space between the cradle and the high voltage battery. Another solution is stiffening the area with the cradle by adding additional cross beams to add additional reinforcement and support to eliminate movement of the rear cradle. Another solution is lower the face of the rear cradle so that more overlap occurs with the high voltage battery extension. Another solution is sufficient rear rail crush space to prohibit movement of the cradle. However, various drawbacks occur from these solutions. More space is required which additionally adds to the length of the vehicle. The cross beams increase the weight of the vehicle. This, in turn, increases the cost of the vehicle. Packaging issues occur with the addition of more parts and manipulating the cradle in the vehicle. Accordingly, the cradle position cannot be changed due to packaging issues.

### SUMMARY

This section provides a general summary of the disclosure, and is not a comprehensive disclosure of its full scope or all of its features.

According to the present disclosure, a snubber bracket is provided that overcomes the deficiencies of the current art. The present snubber bracket does not add any additional part or weight to the vehicle in a minimum weight addition compared to existing solutions. The present disclosure works with existing parts and provides a snubber bracket with a desired stiffness.

According to a first object of the disclosure, a snubber bracket comprises a body with a reinforcing nose extending from the body to provide a crush zone for the snubber. An elongated tail extends from the body. The tail contacts a battery extension to prohibit contact of the snubber bracket with the battery pack. A step is formed between the body and the tail. The step provides an additional crush zone for the snubber bracket. A flange extends from the body and a second flange extends from the tail.

According to a second object of the disclosure, a vehicle comprises a rear cradle with at least one snubber on the cradle. A snubber bracket is coupled with the cradle. The snubber comprises a body with a reinforcing nose extending from the body to provide a crush zone for the snubber. An elongated tail extends from the body. The tail contacts a battery extension to prohibit contact of the snubber bracket with the battery pack. A step is formed between the body and the tail. The step provides an additional crush zone for the snubber bracket. A flange extends from the body and a second flange extends from the tail.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a schematic view of the rear cradle adjacent a high voltage battery pack.

FIG. 2 is a perspective view of the snubber bracket.

FIG. 3 is a schematic side view of the cradle and the battery pack.

FIG. 4 is a figure like FIG. 3 with force applied to the cradle.

Corresponding reference numerals indicate corresponding parts throughout the several views of the drawings.

### DETAILED DESCRIPTION

Example embodiments will now be described more fully with reference to the accompanying drawings.

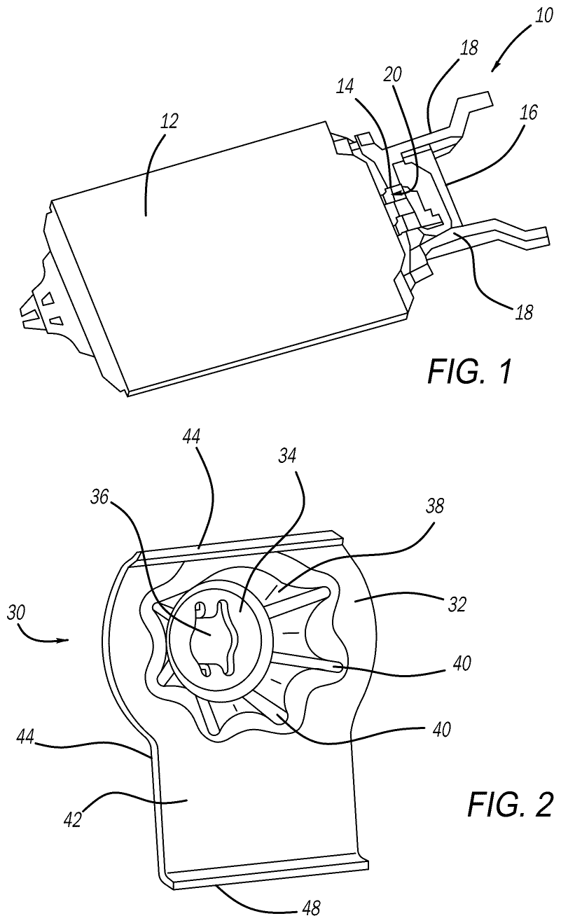

Turning to FIG. 1, a rear cradle 10 is illustrated adjacent to a high voltage battery pack 12. The rear cradle 10 includes a front cross beam 14, rear cross beam 16 and a pair of side beams 18. The front cross beam 14 includes at least one, preferably two, snubbers 20. The snubbers act like shock absorbers to absorb energy during the application of an increased force on the vehicle. The cradle 10 is coupled with the rear suspension components and provides support and reinforcement.

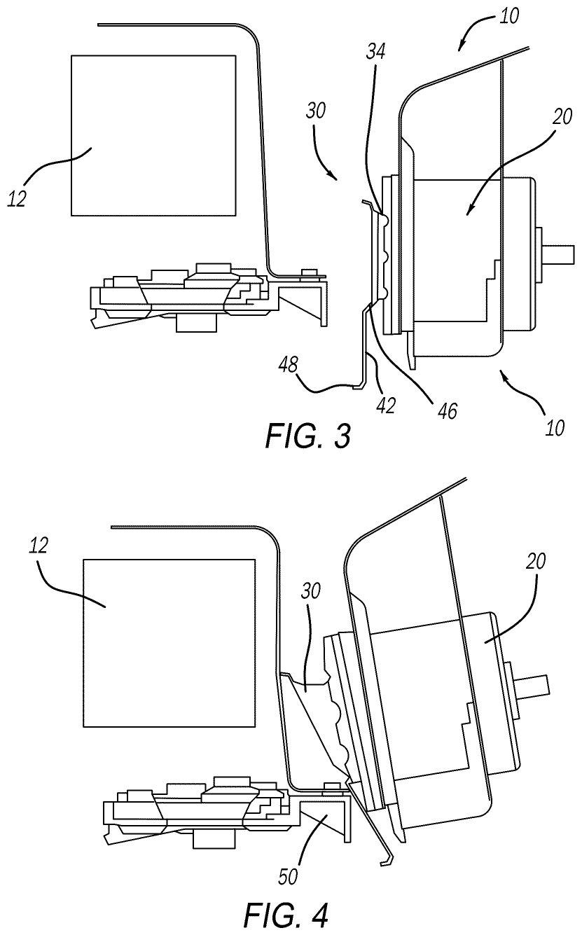

The snubbers 20 include a bracket 30 secured with the snubbers to prohibit the snubber from contacting the high voltage battery module during the application of an increased force. The bracket 30 includes a body portion 32. The body portion includes a nose 34 that provides a crush zone between the body and the snubber. Also, the nose 34 includes a bore 36 to secure with the snubber 20. The nose 34 includes a wall 38 that may include a plurality of indentation 40 to provide reinforcement and energy absorption during impact. The body 32 includes a tail 42 extending away from the body. The body includes a flange 44 on its other side opposing the tail 42. The tail 42 includes a step portion 46 that provides an additional cross zone for the bracket. The end of the tail 42 includes a flange 48. The flange 48 provides additional reinforcement for the bracket and bracket tail. FIG. 3 illustrates a side view of the snubber bracket on the snubber 20 secured with the cradle 10.

As an increased force is applied to the cradle 10, the snubber 20 and bracket 30 contact the battery extension 50 as seen in FIG. 4. As this occurs, the nose crush zone 32 deforms absorbing energy from the force exertion. Also, the step portion 46 contacts the extended battery extension frame deforming it so that the additional crush zone also absorbs the force of the impact. The cradle and snubbers move upward and the tail due to its stiffness prohibits the body of the bracket from contact with the high voltage battery module 12.

Thus, the rear cradle is prohibited from contacting the high voltage battery module. Additionally, no damage will occur to the high voltage battery when the excessive force is applied to the vehicle. The manufacturing of the bracket is relatively simple and does not add any extra parts to the snubber. Additionally, the bracket provides minimum weight to the vehicle. The bracket is more robust under operating conditions with a less amount of additional costs.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A snubber bracket comprising:
a body;
a reinforcing nose extending from the body providing a crush zone for a snubber;
an elongated tail extending from the body, the tail for contacting a battery extension for prohibiting contact of the snubber bracket with the battery pack.

2. The snubber bracket of claim 1, wherein a step is formed between the body and the tail.

3. The snubber bracket of claim 2, wherein the step provides an additional crush zone for the snubber bracket.

4. The snubber bracket of claim 1, wherein a flange extends from the body.

5. The snubber bracket of claim 1, wherein a flange extends from the tail.

6. A vehicle comprising:
a rear cradle with at least one snubber in the cradle and a snubber bracket coupled with the snubber including:
a body;
a reinforcing nose extending from the body providing a crush zone for a snubber;
an elongated tail extending from the body, the tail for contacting a battery extension for prohibiting contact of the snubber bracket with the battery pack.

7. The vehicle of claim 6, wherein a step is formed between the body and the tail.

8. The vehicle of claim 7, wherein the step provides an additional crush zone for the snubber bracket.

9. The vehicle of claim 6, wherein a flange extends from the body.

10. The vehicle of claim 6, wherein a flange extends from the tail.
